(19) United States
(12) Patent Application Publication
(10) Pub. No.: US 2006/0099440 A1
(43) Pub. Date: May 11, 2006

(54) High energy plasma arc process

(76) Inventor: Purusottam Sahoo, Sugar Land, TX (US)

Correspondence Address: Francis C. Hand, Esq.;c/o Carella, Byrne, Bain Gilfillan, Cecchi,, Stewart & Olstein, 5 Becker Farm Road, Roseland, NJ, 07088, US

(21) Appl. No.: 10/984,698

(22) Filed: Nov. 9, 2004

(51) Int. Cl. C03C 27/02; B32B 15/00

(52) U.S. Cl. 428/632; 428/679; 427/446

(57) ABSTRACT

A coating application process using a high energy plasma gun utilizing a low amperage and high voltage stabilized arc to deposit coatings with high deposition efficiency (De) and high bond strength under ASTM C 633 Specification.

This invention relates to a process for applying a high temperature ceramic based coating. More particularly, this invention relates to a process for applying a thermally insulative coating for gas turbines with high bond strength. Still more particularly, this invention relates to a process for applying a zirconia-based thermally insulative coating for gas turbines having a cracked top coat and superior bonding to the bond coat.

### BACKGROUND

A modern gas turbine consists of three sections that function together to produce energy. These are known as the compressor, the combustor, and the turbine sections. In the compressor section, ambient air is compressed and heated by a number of rotating stages of blades in between stationary vanes. This compressed air is passed along to the combustor section where fuel is injected and ignited with the air. The highly compressed and very hot gases, approaching 2600° F. and called the firing temperature, is directed at the turbine section where the energy of heat is transformed into useful power, either for electricity generation or mechanical power.

In order to increase the efficiency of gas turbines, the firing temperature must be increased. As one can imagine from the brief description, the highest temperatures in a gas turbine occur in the first stage vane and rotating blades (sometimes called “buckets”) which spin at high rpm against a ‘shroud’ supported by an engine casing. Current advanced technology heavy frame gas turbines (so called F-technology gas turbines such as GE Frame FA and beyond; Siemens-Westinghouse 501G and beyond) operate at temperatures well above the design limits of many alloys. This is possible only because thermal barrier coatings (TBC) are applied onto the gas path surfaces that are exposed to high temperatures

Because of the high temperature, only certain refractory ceramic materials with properties compatible with the base superalloy can be used as a TBC. Properties that the ceramic material must possess include, but are not limited to:

Resistance to sintering at high temperature

Resistance to erosion or impact damage from fine debris

Resistance to repetitive (or, cyclic) heating and cooling

Low thermal conductivity

Resistance to spallation (delamination) from the bond coat

Typically, for thermal insulation applications, zirconia based coatings (colloquially called YSZ: Yttria partially Stabilized Zirconia) have been used for decades. There are other compositions that are continually being researched and tested as alternatives to YSZ. In actual production, however, there have been very few alternates to this coating. However, if such a composition is found, the findings of this will be applicable to these new compositions. Although there are numerous patents and publications (numbering in the thousands) on the efficacy of this and other materials, the YSZ continues to be predominantly used. However, for those skilled in the art, it is well known that under certain conditions, yttria may be replaced, fully or partially, by oxides such as ceria, india, scandia, lanthania, and the like.

It is known in the art of gas turbine coatings that the desirable properties of a coating are dependent on a variety of factors, including chemical composition, method of application, coating porosity, thickness of the coating, and the existence of cracks (microcracks and macrocracks) in the deposited coating layer(s). It is known that the insulative property is linearly dependent on the thickness of the coating. Typically, for thermal insulation applications, zirconia based coatings have been used for decades. However, in advanced gas turbines, the designer needs more than an insulative coating. The coating must also be cost effective in a production mode and compatible with the rotating member. Very often, the practical lifetime is dependent on how long the ceramic coating can adhere to the underlying bond coat which is partially dependent on the bond strength of the ceramic coating. In order to increase the insulative property of the coatings, the thickness must be increased which leads to a well known drawback, i.e. a decrease in the bond strength of the ceramic coating to the bond coat. Thus, the users have to compromise between achieving good insulative property versus adequate bond strength. Because the coatings are becoming almost a “commodity”, there is great commercial pressure to lower the cost of applying such coatings.

In efforts to produce useful thermal barrier coatings, most coating applicators have utilized a two layer coating system. Typically, the coating system consists of a MCrAlYX (wherein M is Nickel or Cobalt or both; X is Hafnium, Zirconium, Silicon, or combinations thereof, or other reactive elements) bond coat and a ZrO₂—Y₂O₃ top coat. The bond coat acts to provide good adhesion between the metal substrate and the ceramic top coat, while providing good oxidation protection to the underlying substrate alloy. The top coat acts as a heat shield, insulating the substrate alloy; therefore allowing higher operating temperatures and/or reductions in cooling requirements. Numerous studies have shown that the composition and physical characteristics of both the bond coat and the top coat are extremely important in producing a superior thermal barrier coating. The most common top coat material used for a thermal barrier is a nominal 8% yttria partially stabilized zirconia powder.

In applying a typical TBC, both the bond coat and top coat are air plasma sprayed (APS) to specified thickness and microstructural requirements. The porosity of the top coat is controlled to maximize thermal cycle lifetime.

Because of the need to survive many thermal cycles, the top coat should adhere very strongly to the bond coat. Because the bonding of the ceramic top coat to the underlying MCrAlY bond coat is mechanical in nature, the achieved bond strength is sometimes the limiting factor in TBC lifetime. Equipment manufacturers have been trying for decades to design a spray gun that can improve the bond strength of coatings. For many metallic materials this has been achieved by the so-called High Velocity Oxygen Fuel (HVOF) process which significantly increases the velocity of the spray particles at the moment of impact onto the part. This process has enjoyed great success in the market place for the application of the bond coat materials. However, this process is not suitable for applying the TBC top coat for reasons as follows.

Since the HVOF process utilizes the heat of combustion between oxygen and a carbonaceous fuel (such as H₂, CH₄, kerosene, etc.), the maximum flame temperature is limited to well below 6000° F., significantly under the 20,000° F. temperature of a plasma spray gun. Although 6000° F. can melt some ceramics, the high particle velocity shortens the dwell time of the particle so that the particle does not have enough time to melt and thus stick well to the part. This is analogous to one moving a finger rapidly through the flame of a lit candle—if one moves the digit fast enough no pain is felt because the dwell time is too short for the heat to be transferred, This is one of the main reasons why plasma spray guns have continued to be the mainstay of spraying ceramics for the fast few decades. Their high temperature and low speed contributes to particle melting and sticking to the part. The drawback is that the tensile strength is not high.

Another factor that impacts the commercialization of such coatings is the cost of the materials used and the efficiency of deposition using such spray processes. Deposition Efficiency (De) is the product of two factors: Target efficiency (Tₑ) and Sticking efficiency (Sₑ). To illustrate the meaning better, consider the following example: Let us spray 100 grams of powder at a part (note that the jet spray is not always on the part, some of the jet spray is sprayed into the open air in the spray booth). Since a collection of objects tend to disperse, assume that of the 100 grams of powder sprayed, 80 grams hit the target. This means the target efficiency, defined as:

$${T}_{e} = \frac{amount that actually hits the target}{amount aimed at target} = \frac{80}{100} = 80 \%$$

Now, not everything that hits the target actually sticks to the target. Some amount will fall off the part (i.e., zero bond strength). If we assume that 75% (of the 80% that actually hits the part) sticks to the part, the sticking efficiency, defined as:

$${S}_{e} = \frac{amount that actually adheres to object}{amount that actually impacts object} = 75 \%$$

Thus, the final Dₑ=TₑSₑ=0.8×0.75=0.6, or 60%

Thus, of the 100 grams that were sprayed on to the part, only 60 grams stuck to the part.

In actual practice, because the parts have complex and complicated airfoil shapes, the deposition efficiency (De) under production conditions is significantly lower. Often times, the deposition efficiency (De) of actual parts is under 20%. Thus, 80% or more of the spray material is wasted.

The Dₑ is directly related to the cost of coating a part. In order to reduce the cost of wasted materials, equipment manufacturers of spray guns have tried to improve the deposition efficiency of their guns by designing innovative features into the spray gun. Generally, in most industrial processes, when one tries to improve the efficiency of the process, the quality suffers, or vice versa. This is true for most consumer products. In our normal lifestyle, it is universally accepted that quality comes at a cost.

A simple way of improving the deposition efficiency (De) of spraying TBC with a plasma spray gun is to reduce the speed. Thus, a larger fraction of the powder can be melted optimally and eventually impact and stick to the part. The drawback to this is that the lowered velocity tends to reduce the bonding strength of the coating to the part. Bond strength, as used in this context is defined as stated in ASTM C 633 Specification: Degree of adhesion (bonding strength) of a coating to a substrate, or the cohesive strength of the coating in a tension normal to the surface. The experimental technique to determine the bond strength is based on this specification.

U.S. Pat. No. 6,617,049 describes a TBC which includes a dispersion of fine alumina particles within a zirconia-based coating which gives the leading edge of blades improved resistance to erosion and impact damage.

U.S. Pat. No. 5,770,273 describes a process in which an electrical potential difference is created between substrate and plasma gun so as to ion etch the substrate surface and thereby improve the adhesion of the coating.

U.S. Pat. No. 3,958,097 describes a high velocity plasma spray process which presumably improves the deposition efficiency of the coating.

U.S. Pat. No. 5,281,487 describes how the life expectancy of a TBC is increased by adding mullite (a complex ceramic material) to the bond coat.

U.S. Pat. No. 6,102,656 describes a segmented abradable TBC having superior abradability and erosion resistance by precisely controlling the deposition parameters, composition of the layers, and layer particle morphology.

U.S. Pat. No. 6,264,766 describes a TBC system in which improved adhesion is achieved via a complex and complicated pattern of roughening the bond coat prior to applying the ceramic coating.

Praxair Inc. advertises a high energy plasma spray gun (brand name: Plazjet) that generates a high voltage, low amperage plasma resulting in high throughput and electrical efficiency.

Northwest Mettech Corp. of Canada advertises a gun (brand name: Axial III) developed in 1997 that uses multiple electrodes and axial powder feeding to improve efficient heating and melting of powders which they claim results in higher deposition efficiencies.

Sulzer Metco advertises a gun similar to the NW Mettech gun (brand name: Triplex II) that also has three cathodes and claims that the process stability of such a gun leads to higher deposition efficiency.

Progressive Technologies, Inc. (PTI) also advertises a spray gun (brand name: 100HE) with superior deposition efficiencies. U.S. Pat. Nos. 6,669,106; 6,392,189; 6,202,939; 6,114,649; and 5,420,391 describe the same or similar spray guns. As opposed to most industrial use plasma spray guns which use dual gases, this gun uses a ternary gas mixture. PTI claims that the unique anode-cathode design produces an elongated and stabilized plasma arc.

The above cited documents focus on improving one (bond strength) or the other (deposition efficiency) attribute of the coating application process. The prior art and experience has taught that achieving both attributes simultaneously would be almost impossible. Thus, the price (deposition efficiency) of the coating is dependent on the quality (bond strength) of the coating. Generally, there is an inverse relationship between the two. However, in the process of developing a next-generation TBC coating, it was discovered that this precept was violated; i.e., one could get a coating with high quality (i.e. high bond strength) at a lower price (i.e. high deposition efficiency). In layman terms, this is tantamount to obtaining a higher quality product at a lower cost.

Accordingly, it is the object of this invention to utilize a high energy plasma spray gun with a high voltage and low amperage plasma arc to deposit a coating with high deposition efficiency that also has high bond strength.

It is another object of the invention to provide a thermal barrier coating using the improved process to obtain a coating that is vertically cracked and resistant to delamination.

### BRIEF DESCRIPTION OF THE INVENTION

Briefly, the invention provides a process using a high energy gun, in particular a PTI 100HE spray, and operating the gun at low amperage and high voltage plasma arc to apply a thermal barrier coating (TBC) onto a substrate. The TBC is comprised of a MCrAlY bond coat and a top coat of yttria stabilized zirconia wherein the top coat is characterized in being a cracked top coat having a high adhesion to said bond coat and a tensile strength of at least 2000 psi according to ASTM C633.

The improved thermally insulative coating can be applied by processing as follows:

1. Apply a bond coat containing nickel (Ni), cobalt (Co), chromium (Cr), aluminium (Al), yttrium(Y) and other reactive elements, such as hafnium (Hf) and silicon (Si). This can be applied by any thermal spray process, such as plasma (air or vacuum), wire arc, High Velocity Oxygen Fuel (HVOF), EB-PVD(Electron Beam-Physical Vapor Deposition), CVD (Chemical Vapor Deposition), and high temperature dffusion.

2. Apply a TBC predominantly constituting YSZ and other phases known to enhance other attributes of the coating to the bond coat. This coating is applied by using a high energy gun, i.e. a Progressive Technologies, Inc. spray gun, Model 100HE, and operating the spray gun at a low amperage and a high-voltage to obtain a plasma arc.

The following examples demonstrate the scope of the invention.

One gas turbine bucket (the rotating member in the turbine section) was coated with a standard Sulzer Hickham TBC coating (called P23) that has enjoyed good commercial success in the industry for many years, and a second bucket was coated with a TBC using the 100HE plasma gun. An operator was asked to strip the ceramic coating of both buckets using a manual abrasive blaster. The operator found that the 100HE coating was much more difficult to remove than the P23 coating. This is a clear indication of the high adhesion of the top coat to the bond coat.

In another example, tensile bond bars were coated with TBC coatings using a Model 9MB spray gun sold by Sulzer Metco of Westbury, New York and normally utilized by Sulzer Hickham and compared to the TBC applied by the 100HE gun. The powder was supplied by H.C. Starck Inc., of West Chester, Ohio. The table below shows the results of tensile testing, conducted per ASTM C633 specification.

| | | Tensile Strength |
|---|---|---|
| Powder | Spray Gun | (psi) |
| STARCK (No P/H) | 100HE | 3,319 |
| STARCK | 100HE | 4,669 |
| Starck | 9MB | 1,448 |

Thus, compared to an industry standard process, the 100HE gun can improve the bond strength by 130% to 220%. This was a most unexpected finding, given that the deposition efficiency of this process was far superior to the standard 9MB spray gun process.

The high voltage and low amperage operating parameters for the 100HE gun reduces anode-cathode wear and improves the thermal efficiency of the gun. Although the exact thermo-physical reactions of spraying ceramic coatings with this gun are not that well understood, the resulting coating was found to have novel and unexpected properties when using this spray gun.

Examples of spray parameters for a standard (9MB) and the PTI (100HE) gun are given below:

The spray conditions found useful are:

Gun: 9MB with G Nozzle and 9MB63 Electrode

Amps: 575±5

Volts @ console: 80 V minimum

Primary gas: H₂ @ 50 psi; Flow @ 80 scfh

Secondary gas: H₂: Adjust to obtain desired voltage; 60 psi setting

Top coat powder feed rate: 30 grams/minute

Spray distance: 3 inch

100HE Gun:

0.550″ Extra Short Tube Back

| | | |
|---|---|---|
| Argon: | 180 | scfh |
| Nitrogen: | 120 | scfh |
| Hydrogen: | 150 | scfh |
| Amps: | 400 | |
| Volts: | 250 | |
| Spray distance: | 2.5″ | |
| Carrier gas: | 24 | scfh |
| Feed rate | 50 | g/min |

Thus, the voltage in the 100HE gun is set at over three times what is achieved in a standard gun. As noted earlier, the thermo physical implications of spraying a ceramic coating are not that well understood, except for the fact that the bond strength and the deposition efficiency are simultaneously improved over previously known concepts in plasma spraying. It is believed that gases found beneficial in this gun can be various mixtures comprising any of the following gases: Argon, Nitrogen, Hydrogen, Helium.

The 100HE gun should be used with the following parameters:

amperage in the range of from 300 amps to 500 amps.

voltage in the range of from 40 volts to 120 volts.

the powder sprayed at a feed rate of 40 grams to 120 grams per minute.

the deposition efficiency (De) of the powder is at least 50%.

bond coat includes a combination of at least any of nickel, cobalt, chromium, aluminum, yttrium, hafnium, rhenium, tantalum and tungsten.

bond coat includes hafnium and silicon.

bond coat is applied using a thermal spray process selected from the group consisting of plasma spraying, wire arc spraying, HVOF, EB-PVD, CVD and high temperature diffusion.

bond coat is formed to a thickness in the range of from 0.003 inch to 0.010 inch.

top coat is formed to a thickness in the range of from 0.010 inch to 0.050 inch.

The coating that is obtained by the above described process includes a bond coat that is bonded to a substrate, such as a turbine blade, and a top coat that is bonded to the bond coat with a high adhesion, namely at a tensile strength of at least 2000 psi as determined in accordance with ASTM C 633, and preferably, in a range of from 3500 psi to above 10,000 psi.

The invention thus provides an efficient technique for applying a TBC to a substrate using a known spray gun at unique amperages and voltages and obtaining a high deposition efficiency and a coating that has high bond strength.

What is claimed is:

1. A process of applying a coating to a substrate comprising the steps of
applying a MCrAlY bond coat to a substrate; and
spraying a powder including yttria stabilzied zirconia through a high energy gun operating with a low amperage and a high voltage plasma arc onto said bond coat to form a top coat thereon characterized in having a high adhesion to said bond coat and a tensile strength of at least 2000 psi according to ASTM C633.

2. A process as set forth in claim 1 wherein said tensile strength of from 3500 psi to 10,000 psi.

3. A process as set forth in claim 1 wherein said amperage is in the range of from 300 amps to 500 amps.

4. A process as set forth in claim 1 wherein said voltage is in the range of from 190 volts to 310 volts.

5. A process as set forth in claim 1 wherein the powder is sprayed at a feed rate of 50 grams per minute in said step of spraying and the deposition efficiency (De) of the powder is at least 50%.

6. A process as set forth in claim 1 wherein said bond coat includes a combination of any of nickel, cobalt, chromium, aluminum, yttrium, hafnium, silicon, rhenium, tantalum and tungsten.

7. A process as set forth in claim 6 wherein said bond coat includes hafnium and silicon.

8. A process as set forth in claim 1 wherein said bond coat is applied using a thermal spray process selected from the group consisting of plasma spraying, wire arc spraying, HVOF, EB-PVD, CVD and high temperature diffusion.

9. A process as set forth in claim 1 wherein said bond coat is formed to a thickness in the range of from 0.003 inch to 0.010 inch.

10. A process as set forth in claim 1 wherein said top coat is formed to a thickness in the range of from 0.010 inch to 0.050 inch.

11. A thermal barrier coating for a substrate comprising
a MCrAlY bond coat applied to a substrate; and
a top coat on said bond coat characterized in having a high adhesion to said bond coat and a tensile strength of at least 2000 psi according to ASTM C633.

12. A coating as set forth in claim 11 wherein said bond coat includes at least nickel, cobalt, chromium, aluminum and yttrium.

13. A coating as set forth in claim 12 wherein said bond coat includes hafnium and silicon.

14. A coating as set forth in claim 12 wherein said top coat contains yttria stabilzied zirconia.
